(19) United States
(12) Patent Application Publication
(10) Pub. No.: US 2020/0001544 A1
(43) Pub. Date: Jan. 2, 2020

(54) METHOD FOR INSTALLING FILLER TUBE AND INSTALLATION STRUCTURE FOR FILLER TUBE

(71) Applicant: Sumitomo Riko Company Limited, Komaki-shi (JP)

(72) Inventors: Lin JIANG, Komaki-shi (JP); Haruki TSUKADA, Komaki-shi (JP)

(73) Assignee: Sumitomo Riko Company Limited, Komaki-shi (JP)

(21) Appl. No.: 16/570,063

(22) Filed: Sep. 13, 2019

Related U.S. Application Data
(63) Continuation of application No. PCT/JP2019/003614, filed on Feb. 1, 2019.

(30) Foreign Application Priority Data
Mar. 9, 2018 (JP) 2018-042465

(51) Int. Cl. B29C 65/20; B29C 48/00; B29C 48/09; B29C 65/00

(52) U.S. Cl. CPC B29C 65/20; B29C 48/0019; B29K 2101/12; B29C 66/5344; B29C 48/09

(57) ABSTRACT

A method for installing filler tube includes the steps of: preparing a fuel tank including an opening; preparing an intervening member including a cylindrical member body and an annular member flange; preparing a filler tube including a cylindrical tube body and an annular tube flange; arranging the intervening member so that not only the member body is arranged in the interior of the fuel tank through the opening but also the member flange locks to a front-side peripheral face of the opening of the fuel tank; and welding not only the front-side peripheral with the tube flange but also the member flange with the tube flange by arranging a hot plate in a facing space between the front-side peripheral face and the tube flange and then warming the front-side peripheral face, the member flange and the tube flange.

### CROSS REFERENCE TO RELATED APPLICATIONS

The present application is a Continuation application of International Application No. PCT/JP2019/003614, filed on Feb. 1, 2019, which is incorporated herein by reference. The present invention is based on Japanese Patent Application No. 2018-042465, filed on Mar. 9, 2018, the entire contents of which are incorporated herein by reference.

### BACKGROUND OF THE INVENTION

### 1. Field of the Invention

The present invention relates to a method for installing filler tube, and an installation structure for filler tube.

### 2. Description of the Related Art

JP5797690B2, and JP2003-194280A disclose to weld a flange, which is disposed at one of the axial opposite ends of a filler tube, onto a front-side peripheral face of an opening of a fuel tank. Moreover, JP5797690B2 discloses to arrange an intervening member (e.g., an inlet check valve, or the like) in the opening of the fuel tank. The intervening member sits astride the opening of the fuel tank, so that it is arranged on an inner side of the fuel tank and on an inner side of the filler tube.

In a structure that FIG. 2 of JP5797690B2 shows, the intervening member (involving the inlet check valve (being the same hereinafter)) is first fitted into the inner peripheral side of the filler tube by press fitting when installing the filler tube onto the fuel tank. The intervening member is fitted into the filler tube with such a fitting force as it does not come off from the filler tube even at the time of transfer. Thereafter, the flange of the filler tube and the front-side peripheral face of the opening of the fuel tank are warmed, and are then welded with one another. Note herein that, in order to warm the two of them, a heat plate is arranged in a facing space made by putting the front-side peripheral face of the opening of the fuel tank and the flange of the filler tube in a state of facing to one another. The two of them are warmed by bringing them into contact with the heat plate. Then, the heat plate is removed from the facing space to weld the fuel tank with the filler tube. Thus, under such a condition as the intervening member is arranged in the opening of the fuel tank, the filler tube, and the fuel tank are assembled integrally with one another by welding.

Moreover, in another structure that FIG. 3 of JP5797690B2 shows, a claw of the intervening member is first locked to the opening of the fuel tank with the intervening member inserted into the opening when installing the filler tube onto the fuel tank. Thereafter, the flange of the filler tube and the front-side peripheral face of the opening of the fuel tank are warmed, and are then welded with one another. Thus, under the condition that the intervening member is arranged in the opening of the fuel tank, the fuel tank, and the filler tube are assembled integrally with one another by welding.

### SUMMARY OF THE INVENTION

The intervening member disclosed in JP5797690B2 extends toward the inner side of the fuel tank as well as toward the inner side of the filler tube, because it sits astride the opening of the fuel tank. Consequently, the heat plate is formed in a cylindrical shape in order to warm the front-side peripheral face of the opening of the fuel tank and the flange of the filler tube. The cylinder-shaped heat plate, which is arranged on some part of the outer peripheral side of the intervening member, warms the front-side peripheral face of the opening of the fuel tank and the flange of the filler tube. After the warming operation, the fuel tank and filler tube are moved in the axial direction of the opening to remove the heat plate from the facing space between the fuel tank and the flange of the filler tube, and the two of them are then welded with one another.

Note herein that, in order to securely weld the front-side peripheral face of the opening of the fuel tank with the flange of the filler tube, it is required to shorten the time from warming the welding sites in the two of them up to actually welding them. However, the intervening member, which sits astride the opening of the fuel tank to extend toward the both sides of the opening, has prolonged the distance over which the fuel tank and filler tube move for the evacuation of the heat plate from the facing space. Consequently, another means is needed in order to solve the lengthened time from warming the welding sites up to actually welding them. This makes a factor of requiring more costs. That is, allowing the time from warming the welding sites up to actually welding them to shorten makes the intention of lowering costs possible.

The present invention is aimed at providing a method for installing filler tube and an installation structure for filler tube that enable the time from warming the welding sites up to actually welding them to shorten.

### 1. Method for Installing Filler Tube

A method for installing filler tube directed to the present invention comprises the steps of:

preparing a fuel tank including an opening;

preparing an intervening member including a cylindrical member body and an annular member flange bulging outward diametrically from an axial end of the member body, the intervening member having the member flange disposed at an axial end thereof;

preparing a filler tube including a cylindrical tube body and an annular tube flange bulging outward diametrically from an axial end of the tube body;

arranging the intervening member so that not only the member body is arranged on an inner side of the fuel tank through the opening of the fuel tank but also the member flange locks to a front-side peripheral face of the opening of the fuel tank; and

welding not only the front-side peripheral of the fuel tank with the tube flange of the filler tube but also the member flange of the intervening member with the tube flange by arranging a hot plate in a facing space between the front-side peripheral face and the tube flange and then warming the front-side peripheral face, the member flange and the tube flange.

The intervening member comprises the cylindrical member body, and the member flange disposed at an axial end of the member body. The member flange is located at an axial end of the intervening member. Consequently, the intervening member does not have any constituent at all on the opposite side across from the member body beyond the member flange.

Moreover, the intervening member is arranged in the opening of the fuel tank. On this occasion, the member body of the intervening member is arranged in an interior of the fuel tank, and the member flange of the intervening member locks to the front-side peripheral face of the opening of fuel tank. That is, the member flange, which is located at the axial end of the intervening member, is located on the front side of the opening of the fuel tank. Therefore, under the condition that the intervening member is arranged in the opening of the fuel tank, nothing exists, except for the member flange, on the front side beyond the opening of the fuel tank.

In addition, the tube flange of the filler tube, and the front-side peripheral face of the opening of the fuel tank are warmed by the heat plate that is arranged in the facing space made between the front-side peripheral face and the filler tube whose tube flange faces the front-side peripheral face. On this occasion, nothing other than the heat plate exists in the facing space where the heat plate exists. Consequently, the fuel tank, and the filler tube completes their movements over a small distance, respectively, for the evacuation of the heat plate from the facing space. Therefore, it is possible to shorten the time from warming the welding sites up to actually welding them. As a result, it is possible to make a welded state very favorable between the welding sites.

Moreover, the facing space, in which no member exists other than the heat plate, makes it unnecessary to control the interspace between the heat plate and the other member that is not allowed to make contact with the heat plate. Whereas it has been needed conventionally to control the interspace between the inner peripheral face of the heat plate and the outer peripheral face of the intervening member, the present invention eliminates the necessity. Therefore, the present invention permits reducing manufacturing costs by the extent of not requiring the control of interspaces.

In addition, it is not needed to fit the intervening member into the inner peripheral side of the filler tube by press fitting. Consequently, it is not necessary to highly accurately mold the inner peripheral face of the filler tube. As a result, the present invention allows the reduction of manufacturing costs.

### 2. Installation Structure for Filler Tube

An installation structure for filler tube directed to the present invention comprises:

a fuel tank including an opening;

an intervening member including a cylindrical member body arranged on an inner side of the fuel tank through the opening of the fuel tank, and an annular member flange bulging outward diametrically from an axial end of the member body and locking to a front-side peripheral face of the opening of the fuel tank, the intervening member having the member flange disposed at an axial end thereof; and

a filler tube made of resin, and including a cylindrical tube body and an annular tube flange bulging outward diametrically from an axial end of the tube body and welded onto the front-side peripheral face and the member flange.

The present installation structure effects the same advantages as those of the above-described present method for installing filler tube.

### BRIEF DESCRIPTION OF THE DRAWINGS

FIG. 1 is a diagram of a fuel line;

FIG. 2 is an axial cross-sectional view of a filler tube shown in FIG. 1, and illustrates the filler tube put in the linearly state;

FIG. 3 is an enlarged view of a section designated with “III” in FIG. 2;

FIG. 4 is a flowchart illustrating a method for installing the filler tube;

FIG. 5 is a plan view illustrating a manufacturing apparatus for the filler tube;

FIG. 6 is a cross-sectional view taken in the direction of arrows “VI”-“VI” shown in FIG. 5;

FIG. 7 is a diagram illustrating how members are arranged at the initial positions at a step “S4” shown in FIG. 4;

FIG. 8 is a diagram illustrating how an intervening member is inserted into an opening of a fuel tank at a step “S5” shown in FIG. 4;

FIG. 9 is a diagram illustrating how a heat plate is inserted at a step “S6” shown in FIG. 4;

FIG. 10 is a diagram illustrating how the members are arranged at the time of warming at a step “S7” shown in FIG. 4;

FIG. 11 is a diagram illustrating how the heat plate is readied for evacuation at a step “S8” shown in FIG. 4;

FIG. 12 is a diagram illustrating how the heat plate is evacuated at a step “S9” shown in FIG. 4; and

FIG. 13 is a diagram illustrating how the members are arranged at the time of welding at a step “S10” shown in FIG. 4.

### DESCRIPTION OF THE EMBODIMENTS

### 1. Construction of Fuel Line 1

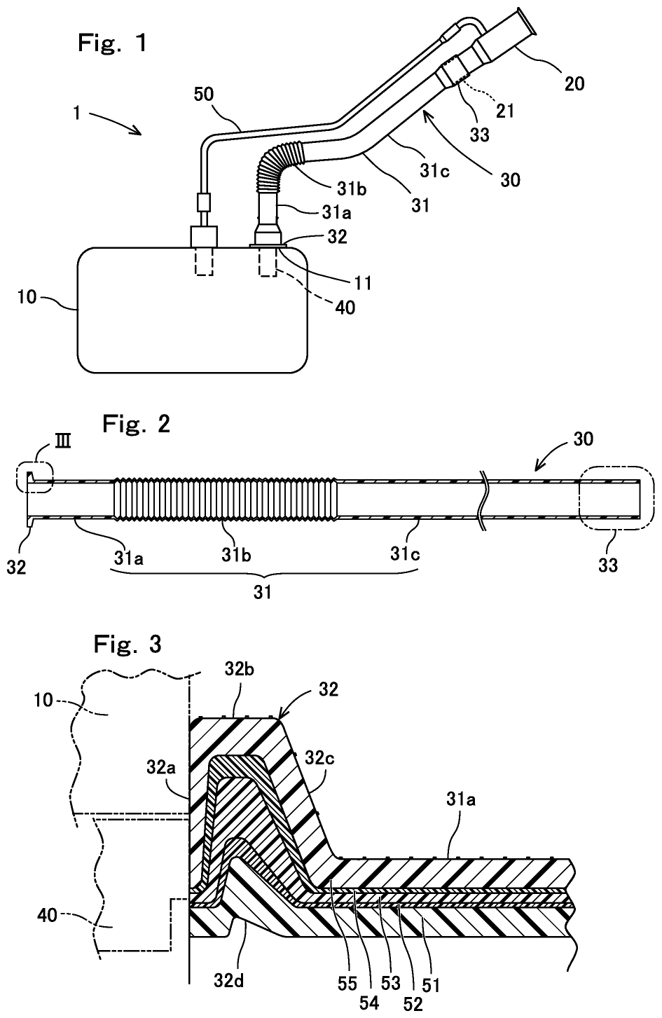

How a fuel line 1 is constructed will be hereinafter described with reference to FIG. 1. The fuel line 1 makes a line from a filler neck and up to an internal combustion engine (not shown) in an automobile. In the present embodiment, however, the fuel line 1 will be hereinafter described while focusing on the part from a filler neck 20 but up to a fuel tank 10.

As illustrated in FIG. 1, the fuel line 1 comprises the fuel tank 10, the filler neck 20, a filler tube 30, an intervening member 40, and a breather line 50. The fuel tank 10, which is molded with thermoplastic resin, reserves a liquid fuel, such as gasoline, in it. The liquid fuel reserved in the fuel tank 10 is supplied to the not-shown internal combustion engine, and is used to drive it. The fuel tank 10 is provided with an opening 11 for supplying fuel. The opening 11 is formed in the top face or side of the fuel tank 10. The filler neck 20 is disposed at around an automobile outer surface through which a fuel supply nozzle (not shown) can be inserted into the filler neck 20.

The filler tube 30, which is molded with thermoplastic resin, connects between the filler neck 20 and the fuel tank 10. The filler tube 30 has an opposite end welded onto a front-side peripheral face of the opening 11 of the fuel tank 10, and another opposite end fitted to and around an insertion portion 21 of the filler neck 20 by press fitting. Inserting the fuel supply nozzle into the filler neck 20, and then supplying a liquid fuel through the fuel nozzle lead to passing the liquid fuel through the filler tube 30 and then holding it in the fuel tank 10. Note herein that, when the fuel tank 10 is fully filled up with the liquid fuel, the liquid fuel, which is held in the filler tube 30 and which makes contact with the leading end of the fuel supply nozzle, stops the supply of the liquid fuel through the fuel supply nozzle automatically. Notice that the filler tube 30, which is formed integrally over the entire length, comprises a linear non-bellows cylindrical segment, a readily-bendable bellows segment, and a curved non-bellows cylindrical segment.

The intervening member 40 is arranged in the opening 11 of the fuel tank 10. Upon supplying a liquid fuel from the filler tube 30 to the fuel tank 10, the liquid fuel passes through the intervening member 40. The intervening member 40 comprises an inlet check valve, for instance. The intervening member 40 comprising an inlet check valve prevents the liquid fuel within the fuel tank 10 from flowing back toward the filler tube 30 when the liquid fuel is supplied from the filler tube 30 to the fuel tank 10.

The breather line 50, which connects the fuel tank 10 with the filler neck 20, is arranged parallel to the filler tube 30. The breather line 50 makes a line for discharging fuel vapors within the fuel tank 10 to the outside of the fuel tank 10 upon supplying the liquid fuel to the fuel tank 10 by way of the filler tube 30.

### 2. Summary on Construction of Filler Tube 30

How the filler tube 30 is constructed will be hereinafter described briefly with reference to FIG. 2. The filler tube 30 has multiple-layered structure made of thermoplastic resins of dissimilar species. As illustrated in FIG. 2, the filler tube 30 comprises a cylindrical tube body 31, an annular tube flange 32 formed at a first axial end of the tube body 31, and a filler-neck end portion 33 formed at a second axial end of the tube body 31.

The tube body 31 is designed suitably so as to make it possible to form piping routes in compliance with the relative positions or distances between the fuel tank 10 and the fuel neck 20, the layouts of peripheral devices, and so on. In the present embodiment, the tube body 31 includes a non-bellows-shaped first cylindrical site 31ₐ, a bellows-shaped site 31_{b}, and a non-bellows-shaped second cylindrical site 31_{c}. The first cylindrical site 31ₐ is formed in a cylindrical shape substantially. The bellows-shaped site 31_{b}, which is connected to the first cylindrical site 31ₐ, is formed as a flexible cylindrical configuration. The second cylindrical site 31_{c} is connected to the bellows-shaped site 31_{b}, and to the filler-neck end portion 33. Moreover, the second cylindrical site 31_{c} is formed so as to flex at the intermediate location.

However, in addition to the above-described tube body 31, the filler tube 30 satisfactorily comprises an alternative tube body 31 including a plurality of bellows-shaped parts, or properly comprises another alternative tube body 31 formed as a bellows-shaped part entirely, or adequately comprises a still another alternative tube body 31 free of any bellows-shaped part at any one of the locations. Moreover, although the second cylindrical site 31, has a non-bellows shape and is formed so as to flex, it is satisfactorily formed in a linear shape.

The tube flange 32 bulges outward diametrically from the first axial end of the tube body 31. The tube flange 32 is welded onto the front-side peripheral face of the opening 11 of the fuel tank 10 over the entire periphery. In addition to the fuel tank 10, the tube flange 32 is also welded onto a later-described member flange 42 of the intervening member 40.

The filler-neck end portion 33, which is formed in a cylindrical shape, is fitted to and around an outer face of the cylindrical insertion portion 21 of the filler neck 20 by press fitting. That is, the filler-neck end portion 33, which has undergone the press fitting, is enlarged diametrically, compared with the filler-neck end portion 33 prior to being subjected to the press fitting.

### 3. Layered Construction of Filler Tube 30

A layered construction of the filler tube 30 will be hereinafter described with reference to FIG. 3. FIG. 3 illustrates some of the tube body 31 on the first-end side, and the tube flange 32.

As illustrated in FIG. 3, the filler tube 30 has a multiple-layered structure made of thermoplastic resins of dissimilar species. The filler tube 30 comprises an innermost layer 51, an inside adhesive layer 52, an intermediate layer 53, an outside adhesive layer 54, and an outermost layer 55, in this order from the inner-layer side. The filler tube 30 has the multiple-layered structure over the entire length.

The innermost layer 51, which makes a face coming in contact with the liquid fuel, is made using a material exhibiting resistance to gasoline. Moreover, when the filler-neck end portion 33 is press fitted to and around the insertion portion 21 of the filler neck 20, the innermost layer 51 is required to exert a hooking force (or come-off preventing force) to the insertion portion 21. Accordingly, the innermost layer 51 is made using a material exhibiting sealing property. Consequently, the innermost layer 51 is formed mainly of high-density polyethylene (or HDPE). However, the use of the other materials is also allowed to form the innermost layer 51 as far as they exhibit the aforementioned properties.

The intermediate layer 53, which is arranged on the outer peripheral side of the innermost layer 51, exhibits fuel-permeation resistance characteristics. The intermediate layer 51 is formed mainly of either an ethylene-vinyl alcohol copolymer (or EVOH) or polyamide (or PA) which exhibits fuel-permeation resistance characteristics. However, the use of the other materials is also allowed to form the intermediate layer 53 as far as they exhibit the aforementioned characteristics.

The outermost layer 55, which is arranged on the outer peripheral side of the intermediate layer 53, protects the intermediate layer 53. The outermost layer 55 makes the outermost face of the filler tube 30. Accordingly, the outermost layer 55 is made using a material exhibiting shock resistance, weatherability, and chemical resistance. Consequently, the outermost layer 55 is formed mainly of either high-density polyethylene (or HDPE) or polyamide (or PA). Moreover, the outermost layer 55 according to the present embodiment makes a layer to be welded onto the fuel tank 10. Consequently, a material, which exhibits favorable welding characteristics to a material for forming the outer face of the fuel tank 10, is applied to form the outermost layer 55. In particular, the outermost layer 55 is adequately formed of the same sort of material as that for forming the outer face of the fuel tank 10. However, the use of the other materials is also allowed to form the outermost layer 55 as far as they exhibit the aforementioned properties.

The inside adhesive layer 52 bonds the outer peripheral face of the innermost layer 51 and the inner peripheral face of the intermediate layer 53 with one another. The outside adhesive layer 54 bonds the outer peripheral face of the intermediate layer 53 and the inner peripheral face of the outermost layer 55 with one another. The inside adhesive layer 52 and outside adhesive layer 54 are formed mainly of modified polyethylene (or modified PE). However, one of the innermost layer 51 and intermediate layer 53, which exhibits adhesive performance to the other one of them, makes the inside adhesive layer 52 unnecessary. Moreover, one of the intermediate layer 53 and outermost layer 55, which exhibits adhesive performance to the other one of them, makes the outside adhesive layer 54 unnecessary.

### 4. Detailed Construction of Tube Flange 32

Next, a detailed construction of the tube flange 32 will be hereinafter described with reference to FIG. 3. The tube flange 32 comprises a weld face 32ₐ (i.e., an axial end face), a maximum-outside-diameter face 32_{b} bulging outward diametrically, a connection outer face 32_{c} connecting between the maximum-outside-diameter 32_{b} and an outer peripheral face of the tube body 31, and an inner peripheral face 32_{d}. The weld face 32ₐ is formed as a face that is parallel to an axially perpendicular direction of the tube flange 32. However, since the weld face 32ₐ is a cut face on the inner peripheral side, it is not necessarily formed as a face that is parallel to the axially perpendicular direction, but is satisfactorily formed so as to make a shape that is dented or depressed axially inward to the right side in FIG. 3. Although the connection outer face 32_{c} is formed in a tapered shape, it is not necessarily formed in that shape limitedly, and it is also allowed to satisfactorily make it into a face that is parallel to the axially perpendicular direction.

Note herein that the above-described tube flange 32 has a multi-layered structure in the same manner as the other sites of the filler tube 30 have. That is, the tube flange 32 comprises the innermost layer 51, the inside adhesive layer 52, the intermediate layer 53, the outside adhesive layer 54, and the outermost layer 55. However, the tube flange 32 has a diametric thickness that is thicker than the diametric thickness of the tube body 31. Consequently, each of the layers in the tube flange 32 has a thickness that becomes thicker than the thickness that each of the layers has in the other sites.

Therefore, the maximum-outside-diameter face 32_{b} and connection outer face 32_{c} of the tube flange 32 are formed of the material for the outermost layer 55. The inner peripheral face 32_{d} is formed of the material for the innermost layer 51. The inner peripheral face 32_{d} is provided with an annular groove dented outward diametrically. The groove is molded upon being subjected to corrugation molding.

Exposed faces of the multiple layers constituting the filler tube 30 exist in the weld face 32ₐ. Note herein that, in the weld face 32ₐ, the innermost layer 51, inside adhesive layer 52, intermediate layer 53 and outside adhesive layer 54 have a thickness equal to a thickness that the sites to be connected to the tube flange 32 have in the tube body 31 (i.e., the sites in the tube body 31 shown in FIG. 3). Therefore, in the weld face 32a, most part of the tube flange 32 bulging outward diametrically is formed of the material for the outermost layer 55. Thus, in the weld face 32ₐ, the part formed of the material for the outermost layer 55 makes a site to be welded onto the fuel tank 10 and intervening member 40. Note, however, that the descriptions herein do not necessarily inhibit the other layers 51 through 54 from being welded onto the intervening member 40.

### 5. Method for Installing Filler Tube 30

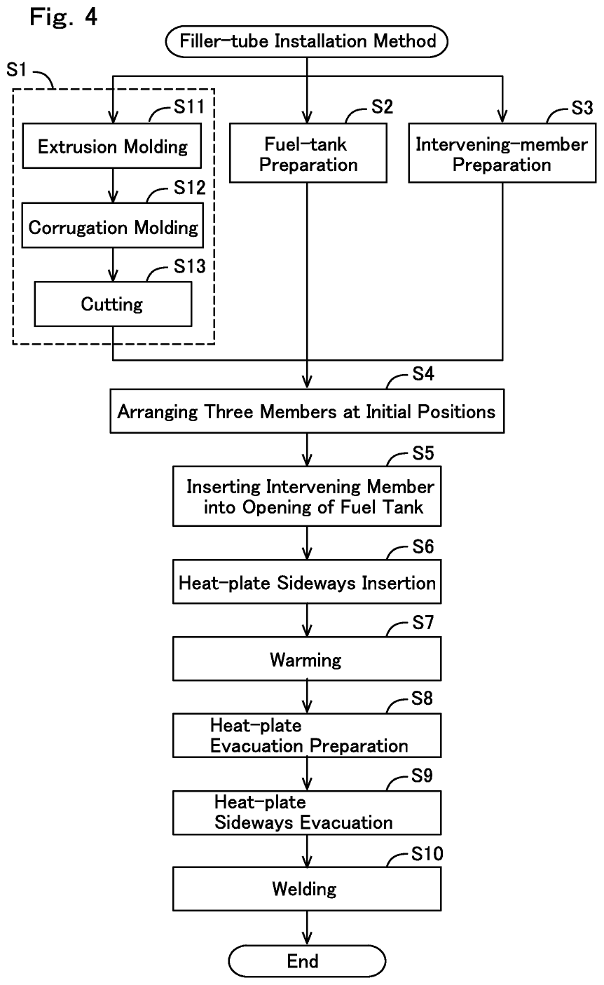

A method for installing the filler tube 30 will be hereinafter described with reference to FIGS. 4 through 13. Note herein that the phrase, “a method for installing the filler tube 30,” involves both meanings: manufacturing the filler tube 30; and welding the filler tube 30 onto the fuel tank 10 and intervening member 40. In other words, the method for installing the filler tube 30 involves a manufacturing method for an installation structure in which the fuel tank 10, the filler tube 30 and the intervening member 40 join with each other.

### 5-1. Step “S1”

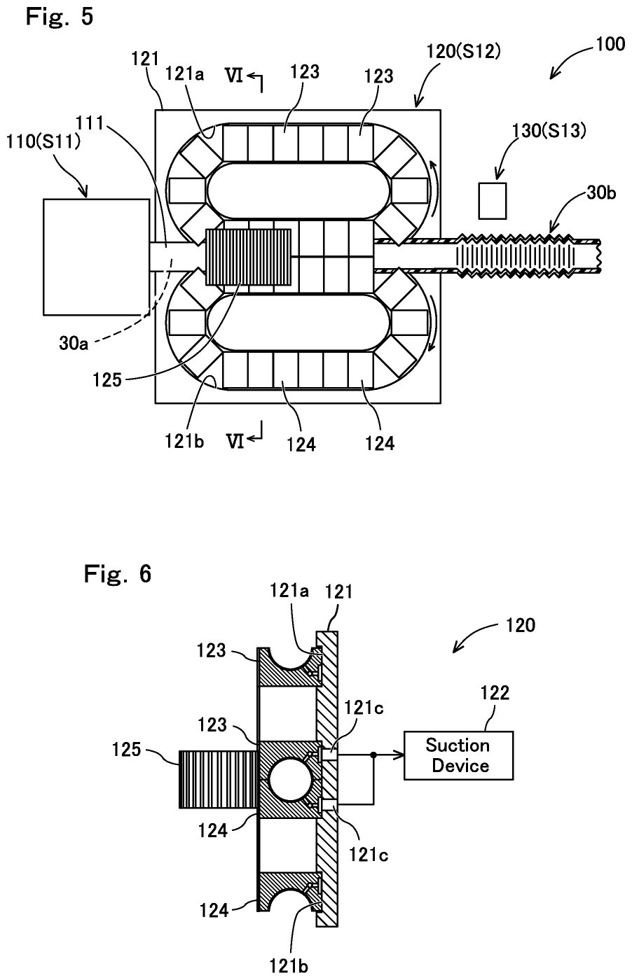

First, the filler tube 30 is prepared at a step “S1” (i.e., a “filler-tube preparation step”). A manufacturing apparatus 100 shown in FIG. 5 manufactures the filler tube 30. The manufacturing apparatus 100 comprises an extruder 110, a corrugation molder 120 successively disposed adjacent to the extruder 110, and a cutter 130 successively disposed adjacent to the corrugation molder 120.

That is, the extruder 110 shown in FIG. 5 molds a primary workpiece 30ₐ at a step “S11.” The corrugation molder 120 shown in FIGS. 5 and 6 molds a secondary workpiece 30_{b} at a step “S12.” The cutter 130 shown in FIG. 5 molds the filler tube 30 at a step “S13.”

The manufacturing apparatus 100 will be hereinafter described with reference to FIGS. 5 and 6. The extruder 110 extrudes the cylindrical primary workpiece 30ₐ at a constant speed. The primary workpiece 30ₐ, which has a multi-layered structure as shown in FIG. 3, is formed in a cylindrical shape having identical inside and outside diameters in the axial direction. That is, the cylindrical workpiece 30ₐ is formed to have a constant thickness diametrically as a whole, and each of the constituent layers is also formed to have a constant thickness diametrically.

The corrugation molder 120 attracts the primary workpiece 30ₐ, which is extruded through a nozzle 111 of the extruder 110, onto the inner peripheral face of multiple dividable molds (123, 124), thereby shaping the extruded primary workpiece 30ₐ in a configuration copying the inner peripheral face of the multiple dividable molds (123, 124). The corrugation molder 120 is applicable to sites for changing the configuration of the primary workpiece 30ₐ extruded through the extruder 110. In the present embodiment, the corrugation molder 120 carries out molding the bellows-shaped site 31_{b}, and molding the tube flange 32.

As illustrated in FIGS. 5 and 6, the corrugation molder 120 comprises a guide stand 121, a suction device 122, the multiple dividable molds (123, 124), and a driving gear 125. In the top face of the guide stand 121, a first guide groove 121ₐ having an oval configuration, and a second guide groove 121_{b} disposed next to the first guide groove 121ₐ and having the same configuration as that of the first guide groove 121ₐ are formed. Moreover, in the guide stand 121, communication bores 121_{c} communicated with the first guide groove 121ₐ and second guide groove 121_{b} are formed as shown in FIG. 6. The suction device 122, which is connected with the communication bores 121_{c} in the guide stand 121 as shown in FIG. 6, suctions or draws out air in an interspace communicated with the communication bores 121_{c}.

The multiple first dividable molds 123 are molds for forming one of imaginary counterparts obtained by cutting the filler tube 30 imaginarily into two segments axially. The multiple first dividable molds 123 move sequentially on and along the first guide groove 121ₐ in the guide stand 121. That is, the multiple first dividable molds 123, each of which moves sequentially, form a half of the filler tube 30. Note herein that each of the multiple first dividable molds 123 is provided with rack teeth formed on the top face.

Moreover, the multiple second dividable molds 124 are molds for forming another one of imaginary counterparts obtained by cutting the filler tube 30 imaginarily into two segments axially. The multiple second dividable molds 124 move sequentially on and along the second guide groove 121_{b} in the guide stand 121. That is, the multiple second dividable molds 124, each of which moves sequentially, form remaining another half of the filler tube 30. Note herein that each of the multiple second dividable molds 124 is provided with rack teeth formed on the top face.

Some of the first dividable molds 123, and some of the second dividable molds 124 have a shaping face corresponding to the bellows-shaped site 31_{b}. The other some of the first dividable molds 123, and the other some of the second dividable molds 124 have a shaping face corresponding to the tube flange 32.

The driving gear 125 is a pinion gear moving the multiple first and second dividable molds (123, 124). The driving gear 125 is arranged at locations above some of mold pairs made by the combination of the multiple first and second dividable molds (123, 124) on a side of the extruder 110 in the manufacturing machine 100. Thus, the driving gear 125, which rotates while meshing the pinion teeth with the rack teeth of the multiple first and second dividable molds (123, 124) placed at the locations below the driving gear 125, moves the multiple first and second dividable molds (123, 124) sequentially.

Moreover, altering the rotary speed of the driving gear 125 allows altering the movement speed of the multiple dividable molds (123, 124). Increasing the movement speed of the multiple dividable molds (123, 124) makes thinner the diametrical thickness of the filler tube 30 at the sections corresponding to some of the multiple dividable molds (123, 124) which are located at around the nozzle 111 of the extruder 110. On the other hand, decreasing the movement speed of the multiple dividable molds (123, 124) makes thicker the diametrical thickness of the filler tube 30 at the sections corresponding to some of the multiple dividable molds (123, 124) which are located at around the nozzle 111 of the extruder 110.

For example, the movement speed of some of the multiple dividable molds (123, 124) corresponding to the tube flange 32 is slower than the movement speed of the other some of the multiple dividable molds (123, 124) corresponding to the non-bellows-shaped first cylindrical site 31ₐ of the tube body 31. Therefore, the tube flange 32 is permitted to have a greater diametrical thickness than the diametrical thickness of the first cylindrical site 31ₐ.

Note herein that the secondary workpiece 30_{b} produced from out of the corrugation molder 120 has an axially continuous configuration. That is, the secondary workpiece 30_{b} has a configuration in which a plurality of the filler tubes 30 are linked with each other. Hence, the cutter 130 cuts the continuous secondary workpiece 30_{b}, which the corrugation molder 120 shapes, to a predetermined length to complete each of the individual filler tubes 30.

Since the extruder 110 and corrugation molder 120 mold the filler tube 30 as described above, the filler tube 30 is molded so that the tube flange 32 has the weld face 32ₐ formed of the material for the outer peripheral face of the primary workpiece 30ₐ (i.e., the material for the outermost layer 55 of the tube body 31). Thus, molding the tube flange 32 by the extruder 110 and corrugation molder 120 eliminates the necessity of using separate or extra press former. Consequently, the use of the extruder 110 and corrugation molder 120 makes possible the reduction of manufacturing costs. Moreover, the use of the extruder 110 and corrugation molder 120 allows forming the weld face 32ₐ of the tube flange 32 of the material for the outermost layer 55 of the tube body 31, as shown in FIG. 3. As a result, the filler tube 30 permits improving the weld face 32ₐ, fuel tank 10 and intervening member 40 in welding performance.

### 5-2. Steps “S2” and “S3”

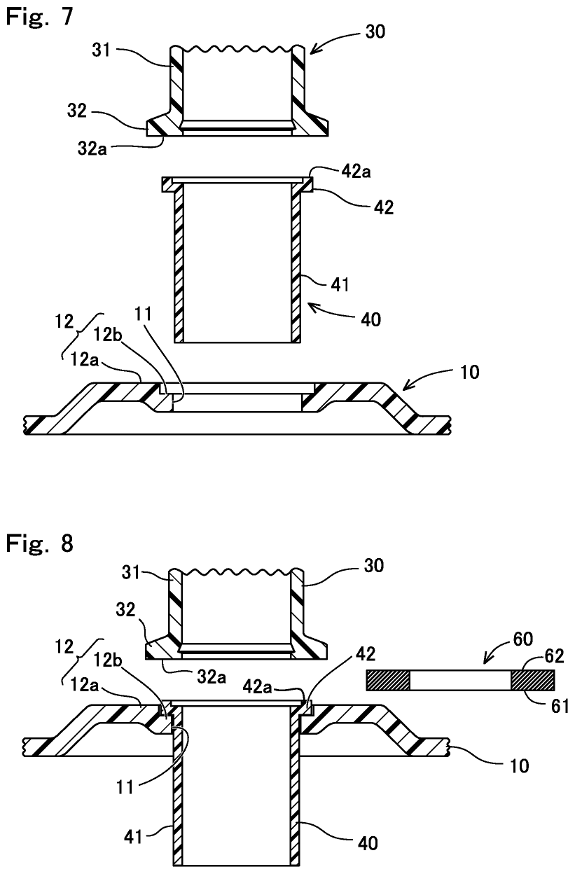

The fuel tank 10 is prepared at a step “S2” shown in FIG. 4 (i.e., a “fuel-tank preparation step”). As illustrated in FIG. 1, the fuel tank 10 comprises the opening 11. A detailed construction at around the opening 11 will be hereinafter described with reference to FIG. 7.

As illustrated in FIG. 7, the opening 11 of the fuel tank 10 has an inner peripheral face formed to have an identical diameter overall in the axial direction. The opening 11 has a front-side peripheral face 12 formed in a stepped shape in the diametric direction of the opening 11. The front-side peripheral face 12 comprises an annular to-be-welded-onto-tube weld face 12ₐ, and an annular dented locker face 12_{b}. The to-be-welded-onto-tube weld face 12ₐ is formed in a planar shape crossing orthogonally with the axial direction of the opening 11. At around the opening 11, the to-be-welded-onto-tube weld face 12ₐ is located most outwardly in the fuel tank 10. The to-be-welded-onto-tube weld face 12ₐ makes a site to be welded onto the weld face 32ₐ of the tube flange 32 of the filler tube 30. The dented locker face 12_{b} is formed nearer to the opening 11 than the to-be-welded-onto-tube weld face 12ₐ. Moreover, the dented locker face 12_{b} is formed to depress more than the to-be-welded-onto-tube weld face 12ₐ. The dented locker face 12_{b} makes a site locking to the member flange 42 of the intervening member 40. That is, the dented locker face 12_{b} is not a face to be welded onto the weld face 32ₐ.

Moreover, the intervening member 40 is prepared at a step “S3” shown in FIG. 4 (i.e., an “intervening-member preparation step”). As illustrated in FIG. 1, the intervening member 40 is arranged in the opening 11 of the fuel tank 10. A detailed configuration of an external form of the intervening member 40 will be hereinafter described with reference to FIG. 7. Note that a functional member is accommodated inside the intervening member 40, although FIG. 7 does not illustrate any internal structure of the intervening member 40. When making the intervening member 40 of an inlet check valve, one of its constituents having a valve function makes the functional constituent to be accommodated inside the intervening member 40.

The intervening member 40 comprises an annular member body 41 accommodating a functional constituent in the interior, and an annular member flange 42 bulging outward diametrically from an axial end of the member body 41. The member body 41 has an outside diameter that is slightly smaller than an inside diameter of the opening 11 of the fuel tank 10.

Note herein that the member flange 42 of the intervening member 40 is located at an axial end of the intervening member 40. That is, the intervening member 40 does not have any constituent on the opposite side across from the member body 41 beyond the member flange 42. Specifically, the intervening member 40 does not have any constituent on the opposite side across from the member body 41 beyond an axial end face of the member flange 42.

Moreover, the member flange 42 has an outside diameter that is slightly smaller than an inside diameter that the dented locker face 12_{b} of the fuel tank 10 has. In addition, the member flange 42 has an axial length that equals a depression depth that the dented locker face 12_{b} has. The axial length of the member flange 42 is satisfactorily identical with the depression depth of the dented locker face 12_{b}, or is also competently shorter than the depression depth slightly, or is even adequately longer than the dented depth slightly. In addition, the member flange 42 includes an annular minor protrusion 42ₐ disposed on the axial end face, and protruding axially. The annular minor protrusion 42ₐ is formed within axial end face of the member flange 42 and adjacently to the outside. Note that it is also possible to construct the member flange 42 free of the annular minor protrusion 42ₐ.

### 5-3. Steps “S4” and “S5”

The fuel tank 10, filler tube 30 and intervening member 40, which have undergone the preparations, are arranged at their initial positions, as illustrated in FIG. 7, at a step “S4” shown in FIG. 4 (i.e., an “initial-position arrangement step”). Arranging them at the initial positions involve the following: arranging the fuel tank 10 so as to direct the opening 11 upward; arranging the intervening member 40, whose member body 41 is located upward and whose member flange 42 is located below, above the opening 11 and coaxially with it; and arranging the filler tube 30 above the intervening member 40. On this occasion, the tube flange 32 of the filler tube 30 is located coaxially with the opening 11 and intervening member 40.

Subsequently, the intervening member 40 is inserted into the opening 11 of the fuel tank 10, as illustrated in FIG. 8, at a step “S5” shown in FIG. 4 (i.e., an “intervening-member insertion step”). Specifically, the member body 41 of the intervening member 40 is inserted through the opening 11 of the fuel tank 10. Thus, the member body 41 of the intervening member 40 is arranged on an inner side of the fuel tank 10. Moreover, the intervening member 40 is arranged so as to lock the member flange 42 to the front-side peripheral face 12 of the opening 11 of the fuel tank 10. In particular, the member flange 42 locks to the dented locker face 12_{b} within the front-side peripheral face 12.

Under the circumstances, the tube flange 32 of the filler tube 32 has the weld face 32ₐ that is arranged so as to provide an interspace for the to-be-welded-onto-tube weld face 12ₐ of the fuel tank 10 and the member flange 42 of the intervening member 40. Then, the heat plate 60 for warming the weld faces (32ₐ, 12ₐ, 42) is arranged sideways or laterally to the interspace. That is, the interval of a facing space between the weld face 32ₐ of the tube flange 30 and the to-be-welded-onto-tube weld face 12ₐ of the fuel tank 10 corresponds to an interval allowing the insertion of the heat plate 60. Note that the flange member 42 of the intervening member 40 includes the annular minor protrusion 42ₐ that protrudes slightly from the to-be-welded-onto-tube weld face 12ₐ. However, it is substantially unnecessary to take the protrusion into consideration because the annular minor protrusion 42ₐ protrudes extremely less. Notice herein that the heat plate 60, which is formed as a hollowed disk shape, has a first face 61 located below and a second face 62 located above. Each of the first and second faces (61, 62) forms a face capable of warming.

Note herein that the opening 11 of the fuel tank 10 has an inside diameter that is larger than an outside diameter that the member body 41 of the intervening member 40 has. Moreover, the inner peripheral face of the dented locker face 12_{b} of the fuel tank 10 has an inside diameter that is larger than an outside diameter that the member flange 42 of the intervening member 40 has. Therefore, the intervening member 40 is readily inserted into the opening 11 of the fuel tank 10 without being inwardly pressed by the opening 11 and dented locker face 12_{b} of the fuel tank 10. Hence, the insertion of the intervening member 40 is carried out with ease.

Moreover, the fuel tank 10 is arranged so as to direct the opening 11 upward, and the member flange 42 of the intervening member 40 locks to the dented locker face 12_{b}. Consequently, gravity acting on the intervening member 40 makes it possible to readily maintain the state of the intervening member 40 under the condition of being inserted into the opening 11 of the fuel tank 10. That is, it is not needed to retain the intervening member 40.

In addition, the intervening member 40 does not include any constituent that bulges beyond the member flange 42 on the opposite side across from the member body 41. Therefore, no bulging constituent exists on the front side (or the outer side) of the opening 11 of the fuel tank 10, except for the member flange 42 that is located at one of the opposite ends of the intervening member 42. Moreover, the front-side peripheral face 12 of the fuel tank 10, and the member flange 42 of the intervening member 40 are located on an equivalent face under the condition of having arranged the intervening member 40 in the opening 11.

Moreover, the intervening member 40 is not inserted into the filler tube 30 at all. Naturally, the pressing operation does not fit the intervening member 40 into the inner peripheral side of the filler tube 30. Consequently, it is not necessary absolutely to contemplate what dimension the filler tube 30 has in the inner peripheral face in relationship with the intervening member 40. Therefore, it is not needed to highly precisely mold the inner peripheral face of the filler tube 30. As a result, it becomes easy to design and manufacture the inner peripheral face of the filler tube 30; and it is possible to reduce the filler tube 30 in manufacturing costs.

Note that, although the present embodiment comprises the heat plate 60 formed as a hollowed disk shape, it also allows forming the heat plate 60 as a solid disk shape. However, from the viewpoint of thermal efficiency, the heat plate 60 is more suitably formed as a hollowed disk shape.

### 5-4. Step “S6”

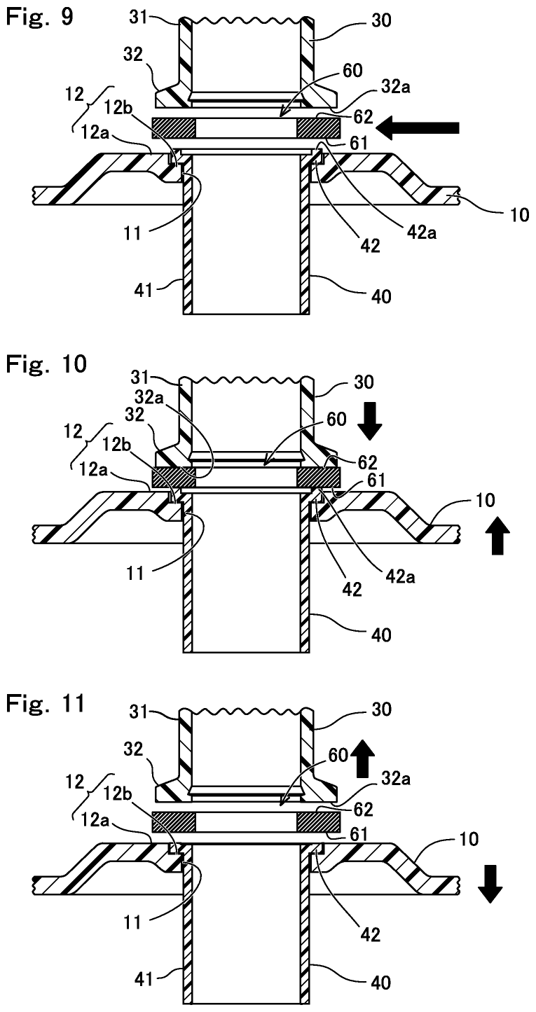

Next, the heat plate 60, which is slid sideways or laterally (i.e., in an axially perpendicular direction of the opening 11), is inserted into the facing space between the weld face 32ₐ of the tube flange 32 of the filler tube 30 and the to-be-welded-onto-tube weld face 12ₐ of the fuel tank 10, as illustrated in FIG. 9, at a step “S6” shown in FIG. 4 (i.e., a “heat-plate insertion step”).

### 5-5. Step “S7”

Subsequently, the fuel tank 10 rising relatively to the heat plate 60 brings the to-be-welded-onto-tube weld face 12ₐ and the member flange 42 of the intervening member 40 into contact with the heat plate 60 as illustrated in FIG. 10. Moreover, the filler tube 30 descending relatively to the heat plate 60 brings the tube flange 32 into contact with the heat plate 60.

Then, the heat plate 60 warms the to-be-welded-onto-tube weld face 12ₐ of the fuel tank 10, the member flange 42 of the intervening member 40, and the weld face 32ₐ of the tube flange 32 at a step “S7” shown in FIG. 4 (i.e., a “warming step”). Specifically, the first face 61 of the heat plate 60 warms the to-be-welded-onto-tube weld face 12ₐ of the fuel tank 10, and the member flange 42 of the intervening member 40. Moreover, the second face 62 of the heat plate 60 warms the weld face 32ₐ of the tube flange 32. That is, the use of the first face 61 and second face 62 of the one-and-only heat plate 60 allows simultaneously warming the to-be-welded-onto-tube weld face 12ₐ of the fuel tank 10, the member flange 42 of the intervening member 40, and the weld face 32ₐ of the tube flange 32.

In addition, the first face 61 of the heat plate 60 warming the member flange 42 gets the material melting in the member flange 42, especially, the material melting at the part of the annular minor protrusion 42ₐ, into the interspace between the member flange 42 and the dented locker face 12_{b} of the fuel tank 10.

Note herein that it should have been necessary conventionally to control the interspace between the inner peripheral face of the heat plate 60 and the outer peripheral face of the intervening member 40, because the intervening member 40 is inserted into the heat plate 60 on the inner peripheral face. However, in the present embodiment, nothing other than the heat plate 60 exists in the facing space where the heat plate 60 exists. Although the heat plate 60 is formed as a hollowed disk shape, no member is inserted into the hollowed region at all. Consequently, it is unnecessary to strictly control the interspace between the heat plate 60 and the other member in the diametric direction (i.e., in the diametric direction of the opening 11). Therefore, it is possible to reduce manufacturing costs to the extent that no control of the interspace is needed.

### 5-6. Steps “S8” and “S9”

Following the warming operation that the heat plate 60 has carried out for a predetermined time, the fuel tank 10 descending relatively to the heat plate 60 separates the to-be-welded-onto-tube weld face 12ₐ and the member flange 42 of the intervening member 40 apart from the heat plate 60, as illustrated in FIG. 11, at a step “S8” shown in FIG. 4 (i.e., an “evacuation preparation step”). Moreover, the tube flange 32 of the filler tube 30 rising relatively to the heat plate 60 separates the tube flange 32 apart from the heat plate 60, as illustrated in FIG. 11, at the step “S8” shown in FIG. 4 (i.e., “the evacuation preparation step”).

Notice herein the following constructions: the member flange 42 is disposed at one of the opposite ends of the intervening member 40; and no constituent exists on the opposite side across from the member body 41 beyond the member flange 42, as described above. Consequently, any constituent, which bulges outward from the front-side peripheral face 12 of the opening 11 of the fuel tank 10, does not virtually exist at all. Therefore, no constituent other the heat plate 60 exists in the facing space where the heat plate 60 exists. For example, no constituent exists in the hollowed region in the heat plate 60 having a hollowed disk shape. The nonexistence of constituent results from the construction in which neither of the fuel tank 10, intervening member 40 and tube flange 32 involves any constituent in the facing space, except for the constituents providing the sites for welding.

Therefore, an extremely small or minute distance is sufficient for moving the to-be-welded-onto-tube weld face 12ₐ of the fuel tank 10, the member flange 42 of the intervening member 40 and the tube flange 32 of the filler tube 30 in order to separate them apart from the heat plate 60. Hence, the present embodiment cuts short the time required for completing the movements.

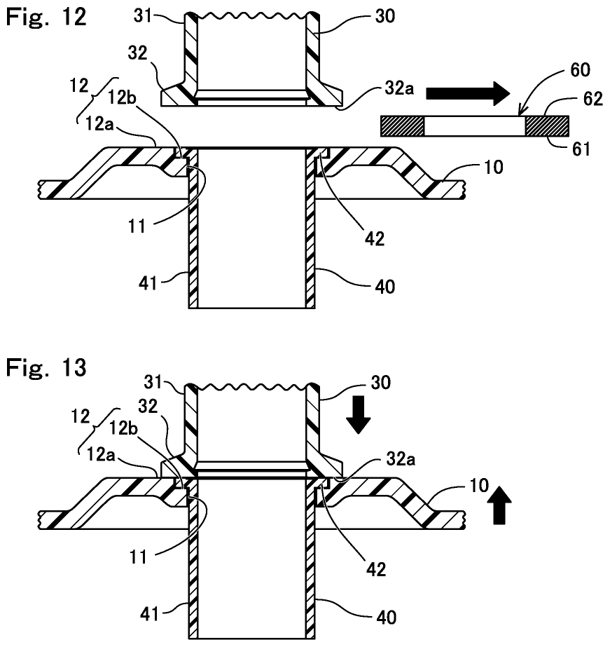

Subsequently, the heat plate 60 is moved to the outside from the facing space between the to-be-welded-onto-tube weld face 12ₐ of the fuel tank 10 and the tube flange 32 of the filler tube 30 by sliding it sideways or laterally (or moving it in an axially perpendicular direction of the opening 11), as illustrated in FIG. 12, at a step “S9” shown in FIG. 4 (i.e., a “heat-plate evacuation step”).

### 5-7. Step “S10”

After the heat plate 60 has been moved as above, the to-be-welded-onto-tube weld face 12ₐ of the fuel tank 10 and the weld face 32ₐ of the tube flange 32 of the filler tube 32 are moved in the up/down direction to weld the to-be-welded-onto-tube weld face 12ₐ and the weld face 32ₐ to one another, as illustrated in FIG. 13, at a Step “S10” shown in FIG. 4 (i.e., a “welding step”). At the same time, the weld face 32ₐ of the tube flange 32 and the member flange 42 of the intervening member 40 are welded to one another at the Step “S10” shown in FIG. 4 (i.e., the “welding step”).

Note herein that a distance over which the fuel tank 10 and tube flange 32 move to weld to one another equals a sum determined by adding a thickness of the heat plate 60 to a distance over which the fuel tank 10 and tube flange 32 move to separate apart from the heat plate 60. As described in the aforementioned evacuation preparation step, the present embodiment allows lessening or shortening a distance over which the fuel tank 10 and tube flange 32 move to separate apart from the heat plate 60. Moreover, the present embodiment permits thinning the heat plate 60 because it is unnecessary to thicken it. Therefore, the present embodiment also allows lessening or shortening a distance over which the fuel tank 10 and tube flange 32 move to weld to one another.

Thus, the to-be-welded-onto-tube weld face 12ₐ of the fuel tank 10, the tube flange 32 of the filler tube 30, and the intervening member 40 make possible shortening a time up to welding them after the heat plate 60 has warmed them. Therefore, the present embodiment allows making welded states between them very favorable.

Note herein that the first face 61 of the heat plate 60 heats the member flange 42 of the intervening member 40 and thereby the molten material for the member flange 42 gets into the interspace between the member flange 42 and the dented locker face 12_{b} of the fuel tank 10. Moreover, the member flange 42 and the dented locker face 12_{b} weld one another simultaneously at the site of the interspace upon welding them. That is, the present embodiment welds the fuel tank 10 and the intervening member 40 one another directly.

Thus, the present embodiment welds each of the following one another directly: the fuel tank 10 and the tube flange 32 of the filler tube 30; the tube flange 32 and the member flange 42 of the intervening member 40; and the member flange 42 and the fuel tank 10. Thus, the present embodiment firmly or strongly joins the three members, the fuel tank 10, the filler tube 30 and the intervening member 40, with each other.

What is claimed is:

1. A method for installing filler tube, the method comprising the steps of:
preparing a fuel tank including an opening;
preparing an intervening member including a cylindrical member body and an annular member flange bulging outward diametrically from an axial end of the member body, the intervening member having the member flange disposed at an axial end thereof;
preparing a filler tube including a cylindrical tube body and an annular tube flange bulging outward diametrically from an axial end of the tube body;
arranging the intervening member so that not only the member body is arranged on an inner side of the fuel tank through the opening of the fuel tank but also the member flange locks to a front-side peripheral face of the opening of the fuel tank; and
welding not only the front-side peripheral of the fuel tank with the tube flange of the filler tube but also the member flange of the intervening member with the tube flange by arranging a hot plate in a facing space between the front-side peripheral face and the tube flange and then warming the front-side peripheral face, the member flange and the tube flange.

2. The method for installing filler tube according to claim 1, wherein:
the front-side peripheral face of the fuel tank includes an annular to-be-welded-onto-tube weld face, and an annular dented locker face formed nearer to the opening than the to-be-welded-onto-tube weld face and formed in a shape dented more than the to-be-welded-onto-tube weld face;
the step of arranging includes arranging the intervening member so that the member flange locks to the dented locker face of the front-side peripheral face of the fuel tank; and
the step of welding includes not only welding the to-be-welded-onto-tube weld face of the front-side peripheral face with the tube flange of the filler tube but also welding the member flange of the intervening member with the tube flange by warming the to-be-welded-onto-tube weld face, the member flange and the tube flange.

3. The method for installing filler tube according to claim 1, wherein the step of welding includes:
arranging the heat plate in a quantity of one in the facing space between the front-side peripheral face of the fuel tank and the member flange of the intervening member;
warming the front-side peripheral face and the member flange by a first face of the heat plate and simultaneously warming the tube flange of the filler tube by a second face of the heat plate;
moving the heat plate to an exterior from the facing space between the front-side peripheral face and the tube flange after warming the front-side peripheral face, the member flange and the tube flange; and
not only welding the front-side peripheral face with the tube flange but also welding the member flange with tube flange after moving the heat plate.

4. The method for installing filler tube according to claim 3, wherein the step of welding further includes:
moving the heat plate, which is separated apart from the front-side peripheral face of the fuel tank, the member flange of the intervening member and the tube flange of the filler tube, to an exterior from the facing space between the front-side peripheral face and the tube flange by relatively moving the heat plate in an axially perpendicular direction of the opening after warming the front-side peripheral face, the member flange and the tube flange.

5. The method for installing filler tube according to claim 1, wherein the step of preparing a filler tube includes:
preparing the filler tube, in which a weld face of the tube flange is formed of a material making an outer peripheral face of a cylindrical primary workpiece extruded through an extruder, by molding the tube body and the tube flange for the primary workpiece using a corrugation molder successively disposed adjacent to the extruder.

6. An installation structure for filler tube, the installation structure comprising:
a fuel tank including an opening;
an intervening member including a cylindrical member body arranged on an inner side of the fuel tank through the opening of the fuel tank, and an annular member flange bulging outward diametrically from an axial end of the member body and locking to a front-side peripheral face of the opening of the fuel tank, the intervening member having the member flange disposed at an axial end thereof; and
a filler tube made of resin, and including a cylindrical tube body and an annular tube flange bulging outward diametrically from an axial end of the tube body and welded onto the front-side peripheral face and the member flange.

7. The installation structure for filler tube according to claim 6, wherein the front-side peripheral face of the fuel tank includes:
an annular to-be-welded-onto-tube weld face welded onto the tube flange of the filler tube; and
an annular dented locker face formed nearer to the opening than the to-be-welded-onto-tube weld face, formed in a shape dented more than the to-be-welded-onto-tube weld face, and locking to the member flange of the intervening member.
